(19) United States
(12) Patent Application Publication
(10) Pub. No.: US 2006/0194114 A1
(43) Pub. Date: Aug. 31, 2006

(54) Positive electrode active material for non-aqueous electrolyte secondary battery, manufacturing method thereof, and non-aqueous electrolyte secondary battery using the positive electrode active material

(75) Inventor: Takaya Saito, Tochigi (JP)

Correspondence Address: MCDERMOTT WILL & EMERY LLP, 600 13TH STREET, N.W., WASHINGTON, DC, 20005-3096, US

(73) Assignee: MATSUSHITA ELECTRIC INDUSTRIAL CO., LTD.

(21) Appl. No.: 11/356,112

(22) Filed: Feb. 17, 2006

(30) Foreign Application Priority Data
Feb. 28, 2005 (JP) 2005-052813

(51) Int. Cl. H01M 4/62; H01M 4/48; C01D 1/02

(52) U.S. Cl. 429/232; 429/231.1; 423/594.15

(57) ABSTRACT

A non-aqueous electrolyte secondary battery includes: a positive electrode including a positive active material made of a transition-metal-containing complex oxide capable of intercalating lithium ions; a non-aqueous electrolytic solution; and a negative electrode for intercalating and de-intercalating the lithium ions. Provided on the surface of the lithium-containing complex oxide are Li₂CO₃, M1₂CO₃, and at least one kind of molecules selected from a group represented by R—COOM2. M1 is at least one kind of elements selected from a group consisting of H, Na, and Li. Li₂CO₃ is excluded from M1₂CO₃. R is at least one kind of functional groups selected from a group consisting of alkyl group, alkenyl group, and alkynyl group. M2 is at least one kind of elements selected from a group consisting of H, Na, and Li.

### BACKGROUND OF THE INVENTION

1. Field of the Invention

The present invention relates to a non-aqueous electrolyte secondary battery and particularly to positive active materials therefor.

2. Background art

Lithium-ion secondary batteries are secondary batteries that have high operating voltage and energy density. For this reason, lithium-ion secondary batteries are put to practical use as a driving power source for portable electronic equipment, such as a portable telephone, a notebook type personal computer, and a video camcorder.

Used as positive active materials for lithium-ion secondary batteries are lithium-containing complex oxides that are oxidized and reduced at high electric potentials of approx. 4V or higher with respect to metal lithium. Specifically, generally used lithium-containing complex oxides are: lithium-cobalt complex oxides (LiCoO₂, and LiCo_{1-(x+y)}MgₓAl_{y}O₂) and lithium-nickel complex oxides (LiNiO₂, LiNi₁₋ₓCoₓO₂, LiNi_{1-(x+y)}CoₓAl_{y}O₂, and LiNi_{1-(x+y)}CoₓMn_{y}O₂) each having a hexagonal structure; lithium-manganese complex oxides (LiMn₂O₄, LiMn₂₋ₓCrₓO₄, LiMn₂₋ₓAlₓO₄, and LiMn₂₋ₓNiₓO₄) and lithium-titanium complex oxides (Li₄Ti₅O₁₂) each having a spinel structure; and mixtures of several of these oxides. Among these, LiCoO₂ is dominant because of its high discharge voltage and energy density.

On the other hand, for a negative electrode, carbon materials capable of intercalating and de-intercalating lithium ions are used. Especially, graphite materials having a flat discharging potential and high capacity density are mainly used.

A binder, and, if necessary, a conductive material and solvent are added to each of these positive active materials and negative active materials, and stirred and mixed, to provide two kinds of paste. The binder is, for example, polyfluorovinylidene or polytetrafluoroethylene. The conductive material is, for example, acetylene black or graphite. Each paste is applied to a metal foil, i.e. a current collector, dried, rolled, and cut into a predetermined dimension, to provide sheet-like electrodes for lithium-ion secondary batteries. As a positive electrode current collector and a negative electrode current collector, aluminum and cupper, for example, are used, respectively.

With recent advancement in the functions of portable telephones, a lithium-ion secondary battery is desired to have higher capacity. To increase the capacity, a technique of broadening the range between charge-end voltage and discharge-end voltage of a battery cell to get more capacity out of the active material is used, in addition to a technique of increasing the packing density of the active material. In the former technique, increasing the charge-end voltage increases the discharging voltage and the discharge capacity. Thus, this technique is considered an effective method of increasing the power capacity (electrical energy).

On the other hand, a positive active material having a high electric potential in a charged state is highly reactive with non-aqueous electrolytic solution. For this reason, batteries using such an active material have problems of its safety and storage. To address these problems, coating the surface of the positive active material with a cellulosic is disclosed in Japanese Patent Unexamined Publication No. 2001-291519. However, a higher charge-end voltage further enhances the reactivity of the positive active material. Even when the surface of the positive active material is coated with a cellulosic, the cellulosic decomposes during storage of the battery at high temperatures, generating a large amount of gases. Thus, air bubbles enter between the positive and negative electrodes, thereby decreasing the effective reaction area, and charge-discharge performance. Additionally, the battery expands or its shut-off valve operates in some cases. When LiCoO₂ is used as the positive active material, breakage of the structure of the active material at high voltages considerably decreases the capacity.

### SUMMARY OF THE INVENTION

A positive active material for a non-aqueous electrolyte secondary battery of the present invention includes a lithium-containing complex oxide capable of intercalating lithium ions, and a carbonate and organic carboxylate provided on the surface of the complex oxide. The carbonate includes Li₂CO₃ and M1₂CO₃. M1 is at least one element selected from a group consisting of H, Na, and Li. M1₂CO₃ does not include Li₂CO₃. Organic carboxylate is at least one kind of molecules selected from a group consisting of general formula R—COOM2. R is at least one functional group selected from a group consisting of alkyl group, alkenyl group, and alkynyl group, and M2 is at least one element selected form a group consisting of H, Na, and Li. In this structure, the surface of the lithium-containing complex oxide is coated with stable materials unlikely to elute into the electrolytic solution. This coating inhibits direct contact between the lithium-containing complex oxide and the electrolytic solution, thereby inhibiting metal elution caused by the reaction between the surface of the positive electrode and the electrolytic solution during storage at high temperatures. This structure thus inhibits decrease in charge-discharge capacity and generation of gases caused by high-temperature storage. Such a positive active material can be obtained by kneading a lithium-containing complex oxide and cellulosic in existence of water, drying the kneaded mixture, and firing it at a temperature of at least 230° C. and less than a temperature causing oxygen deficiency in the lithium-containing complex oxide. For a battery using the positive active material of the present invention, the effects of high-temperature storage and improvement in capacity can be obtained when the battery is used with charge-end voltage of at least 4.3 and at most 4.5V

### BRIEF DESCRIPTION OF THE DRAWING

FIG. 1 is an exploded view in perspective of a non-aqueous electrolyte secondary battery in accordance with an exemplary embodiment of the present invention, showing a partial section thereof.

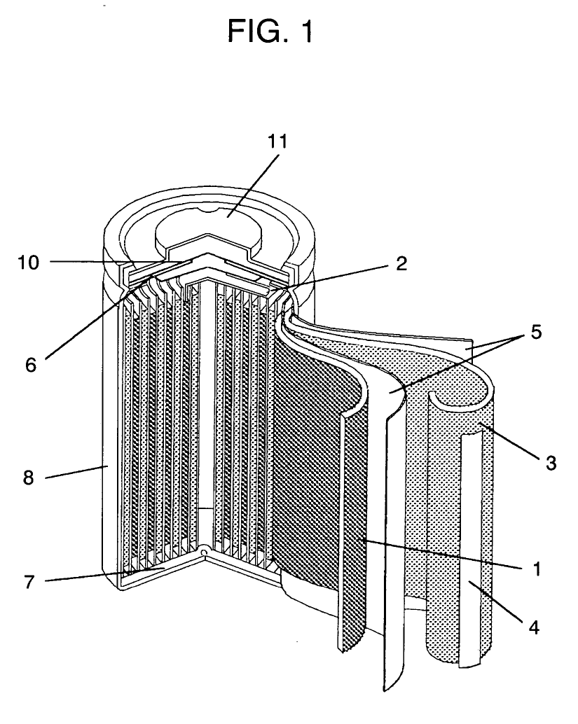

### DETAILED DESCRIPTION OF THE INVENTION

A non-aqueous electrolyte secondary battery of this exemplary embodiment includes positive electrode 1, negative electrode 3, and separator 5 therebetween. Positive electrode 1 has a current collector, mixture layer (neither shown), and positive lead 2 coupled to the current collector. Negative electrode 3 includes a current collector and a mixture layer (neither shown), and negative lead 4 coupled to the current collector. Positive electrode 1, negative electrode 3, and separator 5 are wound to form an electrode group.

To the top of the electrode group, top insulating sheet 6 made of polypropylene is attached. To the bottom of the electrode group, bottom insulating sheet 7 made of polypropylene is attached. Negative lead 4 is joined to the inner bottom of case 8. Positive lead 2 is joined to the bottom of sealing plate 10. Sealing plate 10 covers the opening of case 8. The electrode group is impregnated with a non-aqueous electrolytic solution not shown.

The mixture layer of positive electrode 1 contains a positive active material. The positive active material contains a lithium-containing complex oxide, and Li₂CO₃, M1₂CO₃, and R—COOM2 that are provided on the surface of the lithium-containing complex oxide. The lithium-containing complex oxide is capable of intercalating lithium ions. In M1₂CO₃, M1 is at least one element selected from a group consisting of H, Na, and Li. M1₂CO₃ doesn't include Li₂CO₃. In R—COOM2, R is at least one functional group selected from a group consisting of alkyl group, alkenyl group, and alkynyl group, and M2 is at least one element selected form a group consisting of H, Na, and Li. R—COOM2 is at least one kind of molecules selected from a group consisting of such compounds. In a non-aqueous electrolyte secondary battery using such an active material for positive electrode 1, direct contact between the lithium-containing complex oxide and the electrolytic solution is inhibited. Thereby, the reaction between the surface of the lithium-containing complex oxide and the electrolytic solution is inhibited.

In this reaction, metal elements constituting the lithium-containing complex oxide are eluted. The eluted metal elements are deposited on negative electrode 3, forming coating thereon. Thus, the performance of the battery deteriorates. However, in the positive active material of this embodiment, resultant inhibition of forming the coating on negative electrode 3 maintains the performance of the battery even during high-temperature storage thereof.

Such a positive active material can be prepared by the following processes. First, a lithium-containing complex oxide is mixed with a cellulosic. After addition of water, the mixture is kneaded. Alternatively, an aqueous solution of the cellulosic is prepared and kneaded with the lithium-containing complex oxide. In other words, the lithium-containing complex oxide and cellulosic are kneaded in existence of water. After being dried, the mixture is fired at a temperature of at least 230° C. By either process, the lithium-containing complex oxide can uniformly be coated with Li₂CO₃, M1₂CO₃, and R—COOM2. Such uniform coating can homogenize the reaction, thus improving the storage stability of the battery. Further, because the substances causing gas emission, such as a cellulosic, are fired out, the amount of gas generation and metal elution can be inhibited at a time. When the firing temperature is too high, escape of oxygen from the structure of the lithium-containing complex oxide causes oxygen deficiency, thus deteriorating the charge-discharge performance of the battery. For this reason, it is necessary to fire the mixture at temperatures less than a temperature causing oxygen deficiency in the lithium-containing complex oxide.

The amount of a mixed cellulosic with respect to a lithium-containing complex oxide is preferably at least 0.01 parts by weight and at most 2.0 parts by weight in kneading of the cellulosic and lithium-containing complex oxide. When the amount of the mixed cellulosic is less than 0.01 part by weight, insufficient property modification of the surface of the lithium-containing complex oxide provides smaller effects. When the amount of the mixed cellulosic exceeds 2.0 parts by weight, property modification of the surface of the lithium-containing complex oxide provides larger effects; however, the amount of generated gas increases.

Preferably, the cellulosic is at least one selected from a group consisting of carboxymethyl cellulose and carboxymethylethyl cellulose. Being water-soluble, these cellulosics can be kneaded with a lithium-containing complex oxide, in the form of aqueous solutions. Alternatively, after being mixed with a lithium-containing complex oxide by dry process, each of these cellulosics can be kneaded together with water. By either process, each of these cellulosics can uniformly cover the surface of the lithium-containing complex oxide. Thermal decomposition of these cellulosics in the air allows R—COOM2 to uniformly cover the surface of the lithium-containing complex oxide. Thus, remarkable effects of inhibiting metal elution can be provided.

The R—COO portion in R—COOM2 is generated by thermal decomposition of cellulosics. Cellulosics are easily oxidized. In particular, the reduced end and hydroxyl group are in positions most susceptible to oxidation. It is known that a carboxyl group is introduced to these positions by oxidation. Now, R is rarely made of a single kind of group, and is made of a mixture of a methyl group and/or functional groups such as alkyl group, alkenyl group, and alkynyl group containing two to seven carbons. M2 is at least one element selected from a group consisting of H, Na, and Li. This element is derived from the element at the ends of the cellulosics or lithium-containing complex oxide. M1 in carbonate is also derived from the element at the ends of the cellulosics or lithium-containing complex oxide.

Preferably, the specific surface area of the lithium-containing complex oxide is 1.0 m²/g or smaller. This limits the reaction area, thus further inhibiting metal elution.

The higher the charge-end voltage is, the more metal elutes. However, even when a battery is used at charge-end voltages ranging from 4.3 to 4.5 V, the use of the positive active material of this exemplary embodiment can inhibit metal elution equivalently to a case where the charge-end voltage is 4.2 V. In other words, setting the charge-end voltage of at least 4.3 and at most 4.5 V can provide more remarkable effects of the present invention. Further, increasing the charge-end voltage can considerably improve the cell capacity.

The effects of this exemplary embodiment are described hereinafter with reference to specific experimental results. Firstly, the fabricating method of battery A is described. As a positive active material, a lithium-containing complex oxide represented by a composition formula of Li_{1.05}Ni_{0.33}Co_{0.33}Mn_{0.33}O₂ is used. This lithium-containing complex oxide is prepared in the following manner.

Cobalt sulfate and manganese sulfate are added to a nickel sulfate aqueous solution at a predetermined proportion, to provide a saturated aqueous solution. While this saturated aqueous solution is stirred at low speeds, an alkali solution containing sodium hydrate dissolved therein is dropped for neutralization. In this manner, precipitation of a ternary hydroxide, Ni_{0.33}Co_{0.33}Mn_{0.33}(OH)₂, is generated by the co-precipitation process. This precipitation is filtered and rinsed, and dried at 80° C. The obtained hydroxide has an average particle diameter of approx. 10 μm. This hydroxide is heat-treated in the air at 380° C. for ten hours (hereinafter referred to as primary firing), to provide a ternary oxide, Ni_{0.33}Co_{0.33}Mn_{0.33}O. Powder X-ray diffraction analysis shows that this oxide has a single phase.

Next, lithium hydroxide monohydrate is added to the obtained oxide so that the ratio of the sum of the number of atoms of Ni, Co, and Mn and the number of atoms of Li is 1.00:1.05. Thereafter, the mixture is heat-treated in the dry air at 1,000° C. for ten hours (hereinafter referred to as secondary firing). In this manner, the intended substance, Li_{1.05}Ni_{0.33}Co_{0.33}M_{0.33}O₂ is obtained. Powder X-ray diffraction analysis shows that the obtained lithium-containing complex oxide has a hexagonal layer structure of a single phase and Co and Mn form a solid solution therein. Then, the substance is crushed and classified to provide a lithium-containing complex oxide powder. Its average particle diameter is 8.5 μm; its specific surface area measured by Brunauer-Emmerit-Teller (BET) method is 0.3 m²/g.

To 100 parts by weight of the obtained lithium-containing complex oxide, 0.1 part by weight of a sodium salt of carboxylmethyl cellulose (CMC) is added, and mechanically mixed in a state of powder. After the mixture is sufficiently kneaded while water is gradually added thereto, the mixture is dried at 80° C., pulverized, and classified using a 43-μm mesh. The obtained powder is fired at 250° C., to provide a lithium-containing complex oxide coated with fired CMC. High-frequency inductively coupled plasma emission spectroscopy (ICP), X-ray photoelectron spectroscopy (XPS), and analysis by chemical titration show that the substance coating the surface contains Li₂CO₃, LiNaCO₃, Na₂CO₃, LiHCO₃, NaHCO₃, and R—COONa.

To 100 parts by weight of this active material, 2.5 parts by weight of acetylene black (AB) is added as conductive material. To this mixture, a solution that contains polyvinylidene fluoride (PVdF), as a binder, dissolved in N-methylpyrolidone (NMP), a solvent, is added and kneaded to prepare a paste. The quantity of PVdF added is adjusted so as to be 3 parts by weight with respect to 100 parts by weight of the active material. Subsequently, this paste is applied onto both sides of aluminum foil, i.e. a current collector, dried, rolled, to provide positive electrode 1 having an active material density of 3.30 g/cm³, a thickness of 152 mm, a mixture width of 56.5 mm, and a length of 520 mm.

Next, a description is provided of a method of fabricating negative electrode 3. As a negative active material for intercalating and de-intercalating lithium ions, artificial graphite is used. This artificial graphite has an average particle diameter of approx. 10 μm, a lattice spacing of 002 planes (d002) of 0.348 nm shown by powder X-ray diffraction analysis, and a real density of 2.24 g/cm³. This artificial graphite, styrene-butadiene rubber (SBR), and CMC aqueous solution are mixed. The mixing ratio by weight is artificial graphite:CMC:SBR=100:1:1. The paste prepared in this manner is applied onto both sides of cupper foil, i.e. a current collector, dried and rolled, to provide negative electrode 3 having an active material density of 1.60 g/cm³, a thickness of 0.177 mm, a mixture width of 58.5 mm, and a length of 580 mm.

Positive lead 2 made of aluminum is attached to positive electrode 1, and negative lead 4 made of nickel is attached to negative electrode 3 after a part of the each mixture layer is peeled. Then, positive electrode 1 and negative electrode 3 are wound into a spiral shape, sandwiching separator 5 made of polypropylene (PP) and polyethylene (PE) therebetween, so that an electrode group is formed. To the top of the electrode group, top insulating sheet 6 made of PP is attached. To the bottom thereof, bottom insulating sheet 7 made of PP is attached. The electrode group is then housed into case 8 that is made of nickel-plated iron and has an outside diameter of 18 mm and a height of 65 mm.

As a non-aqueous electrolytic solution, a mixed solvent made of ethylene carbonate (EC), dimethyl carbonate (DMC), and ethylmethyl carbonate (EMC) is used. The mixing ratio by volume is EC:DMC:EMC=20:30:30. Into this mixed solvent, 1.0 mol/dm³ of lithium phosphate hexafluoride (LiPF₆) is dissolved, and 3 wt % of vinylene carbonate (VC) is mixed as an additive. After the non-aqueous electrolytic solution prepared as above is poured into case 8, the opening of case 8 is sealed with sealing plate 10. In this manner, battery A is fabricated.

In order to confirm the effects of battery A of this exemplary embodiment, battery B is fabricated at the same time. For battery B, after Li_{1.05}Ni_{0.33}Co_{0.33}Mn_{0.33}O₂ is obtained in a similar manner to battery A, the lithium-containing complex oxide is not coated with CMC. Other than this difference, battery B is fabricated by the same process as battery A. ICP, XPS, and analysis by chemical titration show that the substance coating the surface contains Li₂CO₃ only.

Firstly, a charge-discharge procedure is conducted on each of batteries A and B fabricated in these manners. In one cycle, the batteries are charged to 4.1V at 480 mA (0.2 C) at an ambient temperature of 20° C., and discharged to 3.0V at 480 mA. After three cycles, the batteries are charged to 4.1V at 480 mA, left at 60° C. for two days, and their initial discharge capacities are checked. Thereafter, various kinds of evaluation tests are conducted on the cells. The initial discharge capacities are checked as follows. After the batteries are charged to 4.4 V at a constant current of 1,680 mA, they are charged until the charging current decreases to 120 mA, while the voltage is kept. Such a method of charging at a constant voltage after charging at a constant current is hereinafter referred to as CCCV charge. Then, the batteries are discharged to 3.0V at a constant current of 480 mA. This charge-discharge cycling is repeated two times. The discharge capacity in the second cycle is defined as the initial discharge capacity.

In the storage test, after the batteries are charged to 4.4V by CCCV charge and stored at 60° C. for twenty days, the discharge capacities are checked again by the method same as that of checking the initial discharge capacities. The ratio of the discharge capacity after storage with respect to the initial discharge capacity is obtained as a capacity recovery rate.

At that time, the discharge capacities of several battery cells are not checked after storage, and the amount of generated gas after storage is analyzed by gas chromatography. Further, another battery cell is disassembled and negative electrode 3 is taken out. The amount of the eluted metal deposited on negative electrode 3 after storage is analyzed by ICP.

Table 1 shows the measurement results of the capacity recovery rate, the amount of generated gas, and the amount of metal elution after storage. The amount of metal elution is converted into a value per the weight of the negative active material taken out.

TABLE 1

| | Capacity recovery | Amount of | Amount of metal |
|---|---|---|---|
| | rate (%) | generated gas (cm³) | elution (ppm) |
| battery A | 90 | 4 | 70 |
| battery B | 77 | 4 | 190 |

Table 1 shows that battery A containing Li₂CO₃, LiNaCO₃, Na₂CO₃, LiHCO₃, NaHCO₃, and R—COONa has a smaller amount of metal elution after storage and an excellent capacity recovery rate. In contrast, for battery B only containing Li₂CO₃, the amount of metal elution after storage is not inhibited and a capacity recovery rate is considerably low.

The above results show it is necessary that the surface of the lithium-containing complex oxide is coated with Li₂CO₃, M1₂CO₃, and R—COOM2.

Next, a description is provided of the results of discussions on firing temperatures shown after the lithium-containing complex oxide and CMC are kneaded with water and dried. Batteries C1 to C5 are fabricated in a similar manner to battery A, except for the firing temperatures shown after Li_{1.05}Ni_{0.33}Co_{0.33}Mn_{0.33}O₂ and CMC are kneaded with water in the process of fabricating the positive active material of battery A. The respective firing temperatures are 100, 230, 300, 600, and 1,000 ° C. The results of ICP, XPS, and analysis by chemical titration show the substances covering the surfaces of the lithium-containing complex oxide used for batteries C1 to C5 contain Li₂CO₃, LiNaCO₃, Na₂CO₃, LiHCO₃, NaHCO₃, and R—COONa.

The method of evaluating each battery is the same as batteries A and B. Table 2 shows the evaluation results and the firing temperature of each battery together with the results of battery A.

TABLE 2

| | Firing | Capacity | Amount of | Amount of |
|---|---|---|---|---|
| | temperature | recovery rate | generated gas | metal elution |
| | (° C.) | (%) | (cm³) | (ppm) |
| battery C1 | 100 | 88 | 9 | 77 |
| battery C2 | 230 | 89 | 6 | 75 |
| battery A | 250 | 90 | 4 | 70 |
| battery C3 | 300 | 90 | 3 | 67 |
| battery C4 | 600 | 91 | 3 | 69 |
| battery C5 | 1100 | 79 | 5 | 167 |

Battery C1 having a firing temperature lower than 230° C. has an inhibited amount of metal elution after storage and excellent capacity recovery rate, but an increased amount of generated gas. It is considered that these results are caused by a large amount of CMC residues that are oxidatively decomposed to generate gases.

In battery C5 having a firing temperature of 1,100° C., the effects of inhibiting metal elusion are small. This is because escape of oxygen from the lithium-containing complex oxide at a firing temperature of 1,100° C. or higher causes oxygen deficiency in the crystal structure, thus promoting the elution of metal elements in the lithium-containing complex oxide. Powder X-ray diffraction shows that the oxygen deficiency occurs at 1,100° C. For this reason, it is preferable that the upper limit of the firing temperature is lower than a temperature causing oxygen deficiency in the lithium-containing complex oxide.

Next, a description is provided of the results of discussions on how to add CMC to the lithium-containing complex oxide. In fabrication of battery D1, 10 parts by weight of CMC 1% aqueous solution prepared by dissolving CMC in water is added to 100 parts by weight of Li_{1.05}Ni_{0.33}Co_{0.33}Mn_{0.33}O₂ in the process of fabricating the positive active material of battery A. Further, further portion of water is gradually added and the mixture is sufficiently kneaded. Other than theses differences, battery D1 is fabricated in a similar manner to battery A.

In fabrication of cell D2, 0.1 part by weight of CMC powder is added to 100 parts by weight of Li_{1.05}Ni_{0.33}Co_{0.33}Mn_{0.33}O₂, and mixed by dry process in the process of fabricating the positive active material of battery A. Other than this difference, battery D2 is fabricated in a similar manner to battery A.

The results of ICP, XPS, and analysis by chemical titration of the positive active materials used for batteries D1 and D2 show that the substances covering the surfaces of the lithium-containing complex oxide contain Li₂CO₃, LiNaCO₃, Na₂CO₃, LiHCO₃, NaHCO₃, and R—COONa.

The methods of evaluating each battery are the same as those of batteries A and B. Table 3 shows evaluation results and the method of adding CMC of each battery together with the results of battery A.

TABLE 3

| | | Capacity | Amount of | Amount of |
|---|---|---|---|---|
| | Method of | recovery rate | generated gas | metal elution |
| | adding CMC | (%) | (cm³) | (ppm) |
| battery A | Kneading with | 90 | 4 | 70 |
| | water after | | | |
| | adding powder | | | |
| battery D1 | Adding | 88 | 4 | 82 |
| | aqueous | | | |
| | solution | | | |
| battery D2 | Mixing by dry | 83 | 4 | 120 |
| | process after | | | |
| | adding powder | | | |

Battery D1, similar to battery A, has a large effect of inhibiting the amount of metal elution after storage, and a large capacity recovery rate. In contrast, battery D2 has a smaller effect of decreasing the amount of metal elution after storage. For battery D2, the cellulosic coats the lithium-containing complex oxide by dry process. Thus, it is considered because CMC is insufficiently dispersed, a larger part of the surface of the lithium-containing complex oxide is not coated with the cellulosic. This is assumed to be a cause of the above results.

The above description shows R—COOM2 can be formed on the surface of the lithium-containing complex oxide by adding CMC powder and kneading the mixture with water, or adding a CMC aqueous solution and kneading the mixture.

Next, a description is provided of the results of discussions on the amount of CMC to be added. Batteries E1 to E5 are fabricated in a similar manner to battery A in the process of fabricating the positive active material of battery A, except for the amount of CMC added when it is mechanically mixed with Li_{1.05}Ni_{0.33}Co_{0.33}Mn_{0.33}O₂ in a state of powder. The respective amounts of CMC added are 0.005, 0.01, 1.0, 2.0, and 3.0 parts by weight. The results of ICP, XPS, and analysis by chemical titration show that the substance coating the surface of the lithium-containing complex oxide used for batteries E1 to E5 contain Li₂CO₃, LiNaCO₃, Na₂CO₃, LiHCO₃, NaHCO₃, and R—COONa.

The methods of evaluating each battery are the same as those of batteries A and B. Table 4 shows evaluation results and the amount of CMC added of each battery together with the results of battery A.

TABLE 4

| | Amount of | Capacity | Amount of | Amount of |
|---|---|---|---|---|
| | CMC added | recovery rate | gas emission | metal elution |
| | (parts by weight) | (%) | (cm³) | (ppm) |
| battery E1 | 0.005 | 83 | 4 | 148 |
| battery E2 | 0.01 | 87 | 3 | 94 |
| battery A | 0.1 | 90 | 4 | 70 |
| battery E3 | 1.0 | 93 | 4 | 64 |
| battery E4 | 2.0 | 95 | 6 | 62 |
| battery E5 | 3.0 | 94 | 10 | 59 |

When the amount of CMC added is smaller than 0.01 part by weight like battery E1, the effect of inhibiting the amount of metal elution after storage is small, and the capacity recovery rate is slightly small. It is considered that these results are caused by insufficient coating of the surface of the lithium-containing complex oxide with CMC.

In battery E5 in which the amount of CMC added exceeds 2%, the amount of generated gas tends to increase. This result is assumed to be caused by the following reasons. An excessive amount of Li₂CO₃, LiNaCO₃, Na₂CO₃, LiHCO₃, NaHCO₃, and R—COONa remaining on the surface decompose and generates gases. For this reason, it is preferable that the amount of CMC added is at least 0.01 parts by weight and at most 2.0 parts by weight with respect to 100 parts by weight of the lithium-containing complex oxide.

Next, a description is provided of the results of discussions on the kinds of cellulosics to be added to the lithium-containing complex oxide. Battery F is fabricated in a similar manner to battery A in the process of fabricating the positive active material of battery A, except that the cellulosic to be mixed with Li_{1.05}Ni_{0.33}Co_{0.33}Mn_{0.33}O₂by dry process is other than CMC. The cellulosic is a sodium salt of carboxymethylethyl cellulous. The results of ICP, XPS, and analysis by chemical titration show that the substance coating the surface of the lithium-containing complex oxide used for cell F1 contain Li₂CO₃, LiNaCO₃, Na₂CO₃, LiHCO₃, NaHCO₃, and R—COONa.

The methods of evaluating battery F are the same as those of batteries A and B. Table 5 shows evaluation results and the kind of cellulosic of battery F together with the results of battery A.

TABLE 5

| | | Capacity | Amount of | Amout of |
|---|---|---|---|---|
| | | recovery rate | gas emission | metal elution |
| | Cellulosic | (%) | (cm³) | (ppm) |
| battery A | Sodium salt of | 90 | 4 | 70 |
| | carboxymethyl | | | |
| | cellulose | | | |
| battery F | Sodium salt of | 90 | 4 | 78 |
| | carboxymethyl- | | | |
| | ethyl cellulose | | | |

The results of Table 5 show that using sodium salt of carboxymethylethyl cellulose as a cellulosic can provide the same effects as using CMC. Additionally, water-soluble cellulose other than these cellulosics or alkali metal salts thereof can be used. Cellulose has many hydroxyl groups in the molecular chain thereof. Strong hydrogen bonds between these hydroxyl groups inhibit cellulose from being dissolved in water. Thus, substituting the hydrogen atoms in a part of hydroxyl groups for a hydrophobic alkyl group, or a weakly hydrophilic hydroxyalkyl group or carboxyalkyl group can render water-solubility. The cellulosics can be used independently or in combination.

Next, a description is provided of the results of discussions on the specific surface areas of the lithium-containing complex oxide. In batteries G1 and G2, the primary and secondary firing temperatures of Li_{1.05}Ni_{0.33}Co_{0.33}Mn_{0.33}O₂ are controlled in the process of fabricating the positive active material of battery A so that the specific surface areas thereof are different from that of battery A. Other than this difference, batteries G1 and G2 are fabricated by the same process as battery A. For battery G1, the primary firing temperature is controlled to 120° C., the secondary filing temperature is controlled to 800°, and the specific surface area of Li_{1.05}Ni_{0.33}Co_{0.33}Mn_{0.33}O₂ is 1.0 m²/g. For battery G2, the primary filing temperature is controlled to 250° C., the secondary firing temperature is controlled to 900°, and the specific surface area of Li_{1.05}Ni_{0.33}Co_{0.33}Mn_{0.33}O₂ is 1.5 m²/g.

The methods of evaluating battery cell are the same as those of batteries A and B. Table 6 shows evaluation results and the specific surface area of the lithium-containing complex oxide of each battery together with the results of battery A.

TABLE 6

| | Specific | Capacity | Amount of | Amount of |
|---|---|---|---|---|
| | surface area | recovery rate | generated gas | metal elution |
| | (m²/g) | (%) | (cm³) | (ppm) |
| battery A | 0.3 | 90 | 4 | 70 |
| battery G1 | 1.0 | 87 | 7 | 98 |
| battery G2 | 1.5 | 83 | 10 | 123 |

As obvious from Table 6, battery G2 that has a specific surface area larger than 1.0 m²/g has smaller effects of inhibiting the amount of metal elution and an increased amount of generated gas. According to this result, it is preferable that the specific surface area is 1.0 m²/g or smaller. On the contrary, because the reaction area is smaller in a smaller specific surface area, high-load discharge characteristics decrease. For this reason, the specific surface area is preferably 0.1 m²/g or large; more preferably, 0.2 m²/g or large.

Next, a description is provided of the results of the discussions on the composition of lithium-containing complex oxides. First, the amount of lithium ions contained in the lithium-containing complex oxides is discussed.

In batteries H1 and H2, changing the mixing ratio of a ternary oxide of Ni_{0.33}Co_{0.33}Mn_{0.33}O and lithium hydroxide monohydrate changes the x value in LiₓNi_{0.33}Co_{0.33}Mn_{0.33}O₂. Other than this difference, batteries H1 and H2 are fabricated in a similar manner to battery A.

In fabrication of battery H1, lithium hydroxide monohydrate is added so that the ratio of the sum of the number of atoms of Ni, Co, and Mn and the number of atoms of Li is 1.00:1.00. By performing the secondary firing thereafter, intended Li_{1.00}Ni_{0.33}Co_{0.33}Mn_{0.33}O₂ is obtained. Powder X-ray diffraction shows that the obtained lithium-containing complex oxide has a hexagonal layer structure of a single phase. After the oxide is pulverized and classified, lithium-containing complex oxide powder is obtained. The specific surface area measured by the BET method is 0.4 m²/g.

In fabrication of battery H2, lithium hydroxide monohydrate is added so that the ratio of the sum of the number of atoms of Ni, Co, and Mn and the number of atoms of Li is 1.00:1.12. By performing the secondary firing thereafter, intended Li_{1.12}Ni_{0.33}Co_{0.33}Mn_{0.33}O₂ is obtained. Powder X-ray diffraction analysis shows that the obtained lithium-containing complex oxide has a hexagonal layer structure of a single phase. After the oxide is pulverized and classified, lithium-containing complex oxide powder is obtained. The specific surface area measured by the BET method is 0.2 m²/g.

The methods of evaluating each battery are the same as those of batteries A and B. Table 7 shows evaluation results and the amount of lithium ions contained in the lithium-containing complex oxide of each cell together with the results of battery A.

TABLE 7

| | | Capacity | Amount of | Amount of |
|---|---|---|---|---|
| | | recovery rate | generated gas | metal elution |
| | X value | (%) | (cm³) | (ppm) |
| battery H1 | 1.00 | 87 | 3 | 80 |
| battery A | 1.05 | 90 | 4 | 70 |
| battery H2 | 1.12 | 92 | 7 | 71 |

Next, a description is provided of the results of discussions on the y and z values in Li_{1.05}Ni_{1-(y+z)}Co_{y}Mn_{Z}O₂, i.e. the ratio of metal elements other than lithium. In battery J1 to J4, in the process of fabricating the positive active material of battery A, the composition ratios of the ternary hydrates are changed. At that time, saturated aqueous solutions are prepared at ratios of cobalt sulfate and manganese sulfate to be added to the nickel sulfate aqueous solution different from that of battery A. Other than this difference, batteries J1 to J4 are fabricated in a similar manner to battery A.

In fabrication of battery J1, precipitation of a ternary hydroxide, Ni_{0.57}Co_{0.1}Mi_{0.33}(OH)₂, is generated by neutralizing a saturated aqueous solution of a sulfate by the co-precipitation process. The specific surface area of Li_{1.05}Ni_{0.57}Co_{0.1}Mn_{0.33}O₂ prepared using this substance and measured by the BET method is 0.3 m²/g.

In fabrication of battery J2, precipitation of a ternary hydroxide, Ni_{0.33}Co_{0.35}Mn_{0.32}(OH)₂, is generated by neutralizing a saturated aqueous solution of a sulfate by the co-precipitation process. The specific surface area of Li_{1.05}Ni_{0.33}Co_{0.35}Mn_{0.32}O₂ prepared using this substance and measured by the BET method is 0.3 m²/g.

In fabrication of cell J3, precipitation of a ternary hydroxide, Ni_{0.66}Co_{0.33}Mn_{0.01}(OH)₂, is generated by neutralizing a saturated aqueous solution of a sulfate by the co-precipitation process. The specific surface area of Li_{1.05}Ni_{0.66}Co_{0.33}Mn_{0.01}O₂ prepared using this substance and measured by the BET method is 0.3 m²/g.

In fabrication of cell J4, precipitation of a ternary hydroxide, Ni_{0.35}Co_{0.30}Mn_{0.35}(OH)₂, is generated by neutralizing a saturated aqueous solution of a sulfate by the co-precipitation process. The specific surface area of Li_{1.05}Ni_{0.35}Co_{0.30}Mn_{0.35}O₂ prepared using this substance and measured by the BET method is 0.3 m²/g.

The methods of evaluating each battery are the same as those of batteries A and B. Table 8 shows evaluation results and the x and y values of each battery together with the results of battery A.

TABLE 8

| | | | | Amount of | Amount of |
|---|---|---|---|---|---|
| | | | Capacity | gas | metal |
| | | | recovery | emission | elution |
| | Y value | Z value | rate (%) | (cm³) | (ppm) |
| battery A | 0.33 | 0.33 | 90 | 4 | 70 |
| battery J1 | 0.1 | 0.33 | 90 | 5 | 73 |
| battery J2 | 0.35 | 0.32 | 91 | 4 | 71 |
| battery J3 | 0.33 | 0.01 | 93 | 4 | 63 |
| battery J4 | 0.30 | 0.35 | 88 | 4 | 72 |

Next, a description is provided of the results of discussions on cases where other metal elements are used in place of Mn in LiₓNi_{-(y+z)}Co_{y}Mn_{z}O₂. In batteries K1 to K6, in the process of fabricating the positive active material of battery A, the composition ratios of the ternary nickel hydrates are changed. At that time, saturated aqueous solutions are prepared by addition of cobalt sulfate and a sulfate of a metal other than manganese. Other than this difference, batteries K1 to K6 are fabricated in a similar manner to battery A. In this manner, lithium-containing complex oxides containing metal elements other than manganese as a third metal element except lithium are used for positive active materials.

In fabrication of battery K1, cobalt sulfate and aluminum sulfate are added to a nickel sulfate aqueous solution to provide a saturated aqueous solution. Precipitation of a ternary hydroxide, Ni_{0.82}Co_{0.15}Al_{0.03}(OH)₂, is generated by neutralizing the saturated aqueous solution by the co-precipitation process. This precipitation is filtered, rinsed, and dried at 80° C. The obtained ternary hydroxide is heat-treated in the air at 600° C. for ten hours, to provide a ternary oxide, Ni_{0.82}Co_{0.15}Al_{0.03}O. Next, lithium hydroxide monohydrate is added to the obtained Ni_{0.82}Co_{0.15}Al_{0.03}O so that the ratio of the sum of the number of atoms of Ni, Co, and Al and the number of atoms of Li is 1.00:1.01. Then, the mixture is heat-treated in the dry air at 800° C. for ten hours, to provide intended Li_{1.01}Ni_{0.82}Co_{0.15}Al_{0.03}O₂. Powder X-ray diffraction analysis shows that the obtained lithium-containing complex oxide has a hexagonal layer structure of a single phase and Co and Al form a solid solution therein. Then, the substance is pulverized and classified to provide a lithium-containing complex oxide powder. Its specific surface area measured by the BET method is 0.3 m²/g.

In fabrication of battery K2, cobalt sulfate and titanium sulfate are added to a nickel sulfate aqueous solution to provide a saturated aqueous solution. Precipitation of a ternary hydroxide, Ni_{0.82}Co_{0.15}Ti_{0.03}(OH)₂, is generated by neutralizing the saturated aqueous solution by the co-precipitation process. Li_{1.01}Ni_{0.82}Co_{0.15}Ti_{0.03}O₂ having a specific surface area of 0.3 m²/g measured by the BET method is obtained by the similar process to battery K1, other than this difference.

In fabrication of battery K3, cobalt sulfate and magnesium sulfate are added to a nickel sulfate aqueous solution to provide a saturated aqueous solution. Precipitation of a ternary hydroxide, Ni_{0.82}Co_{0.15}Mg_{0.03}(OH)₂, is generated by neutralizing the saturated aqueous solution by the co-precipitation process. Li_{1.01}Ni_{0.82}Co_{0.15}Mg_{0.03}O₂ having a specific surface area of 0.3 m²/g measured by the BET method is obtained by the similar process to battery K1, other than this difference.

In fabrication of battery K4, cobalt sulfate and molybdenum sulfate are added to a nickel sulfate aqueous solution to provide a saturated aqueous solution. Precipitation of a ternary hydroxide, Ni_{0.82}Co_{0.15}Mg_{0.03}(OH)₂, is generated by neutralizing the saturated aqueous solution by the co-precipitation process. Li_{1.01}Ni_{0.82}Co_{0.15}Mo_{0.03}O₂ having a specific surface area of 0.3 m²/g measured by the BET method is obtained by the similar process to battery K1, other than this difference.

In fabrication of battery K5, cobalt sulfate and yttrium sulfate are added to a nickel sulfate aqueous solution to provide a saturated aqueous solution. Precipitation of a ternary hydroxide, Ni_{0.82}Co_{0.15}Y_{0.03}(OH)₂, is generated by neutralizing the saturated aqueous solution by the co-precipitation process. Li_{1.01}Ni_{0.82}Co_{0.15}Y_{0.03}O₂ having a specific surface area of 0.3 m²/g measured by the BET method is obtained by the similar process to battery K1, other than this difference.

In fabrication of battery K6, cobalt sulfate and zirconium sulfate are added to a nickel sulfate aqueous solution to provide a saturated aqueous solution. Precipitation of a ternary nickel hydroxide, Ni_{0.82}Co_{0.15}Zr_{0.03}(OH)₂, is generated by neutralizing the saturated aqueous solution by the co-precipitation process. Li_{1.01}Ni_{0.82}Co_{0.15}Zr_{0.03}O₂ having a specific surface area of 0.3 m²/g measured by the BET method is obtained by the similar process to battery K1, other than this difference.

Further, a case where the metal elements other than lithium are quaternary is discussed. In battery K7, in the process of fabricating the positive active material of battery A, a quaternary hydroxide is used in place of a ternary hydroxide. At that time, cobalt sulfate, manganese sulfate, and aluminum sulfate are added to a nickel sulfate aqueous solution to provide a saturated aqueous solution. Precipitation of a quaternary hydroxide, Ni_{0.40}Co_{0.30}Mn_{0.27}Al_{0.03}(OH)₂, is generated by neutralizing the saturated aqueous solution by the co-precipitation process. Li_{1.05}Ni_{0.40}Co_{0.30}Mn_{0.27}Al_{0.03}O₂ having a specific surface area of 0.3 m²/g measured by the BET method is obtained by the similar process to battery K1, other than this difference. Battery K7 is fabricated using this lithium-containing complex oxide.

The methods of evaluating each battery are the same as those of batteries A and B. Table 9 shows evaluation results and the third metal element (and fourth metal element) of each battery together with the results of battery A.

TABLE 9

| | | Capacity | Amount of | Amount of |
|---|---|---|---|---|
| | Third metal | recovery rate | generated gas | metal elution |
| | element | (%) | (cm³) | (ppm) |
| battery A | Mn | 90 | 4 | 70 |
| battery K1 | Al | 85 | 7 | 34 |
| battery K2 | Ti | 83 | 6 | 38 |
| battery K3 | Mg | 81 | 7 | 55 |
| battery K4 | Mo | 84 | 8 | 48 |
| battery K5 | Y | 89 | 7 | 37 |
| battery K6 | Zr | 88 | 6 | 53 |
| battery K7 | Mn + Al | 95 | 3 | 42 |

The results in Tables 7 to 9 show that the similar effects can be provided by any lithium-containing complex oxide represented by a general formula of LiₓNi_{1-(y+z)}Co_{y}M_{z}O₂ (1.00≦x≦1.12, 0.1≦y≦0.35, 0.01≦z≦0.35, M being at least one kind of elements selected from a group consisting of Al, Mn, Ti, Mg, Mo, Y, and Zr), as a positive active material.

Table 10 shows the results of discussions on the discharge capacity and storage characteristics of the batteries using the positive active material of the exemplary embodiment, using batteries A and B at different charge-end voltages.

TABLE 10

| | | | | |
|---|---|---|---|---|
| | Initial discharge | | Capacity | Amount of |
| Charge-end | capacity | | recovery rate | metal elution |
| voltage (V) | (mAh) | battery | (%) | (ppm) |

| | | | | |
|---|---|---|---|---|
| 4.2 | 2040 | A | 93 | 12 |
| | | B | 92 | 23 |
| 4.3 | 2180 | A | 92 | 24 |
| | | B | 81 | 65 |
| 4.4 | 2400 | A | 90 | 70 |
| | | B | 77 | 190 |
| 4.5 | 2500 | A | 85 | 130 |
| | | B | 61 | 320 |
| 4.6 | 2570 | A | 67 | 220 |
| | | B | 59 | 450 |

As obvious from Table 10, the effects of the structure of the present invention are remarkable at charge-end voltages of at least 4.3 V At a charge-end voltage less than 4.3V (namely at 4.2V), the amount of metal elution is small. For this reason, there is only little difference between battery A and B; thus the effects of the structure of the present invention are small. At a charge-end voltage exceeding 4.5V (namely at 4.6V), the effects of inhibiting the amount of metal elution are shown in battery A; however, the components of the electrolytic solution are oxidatively decomposed. For this reason, the recovery rate after storage of battery A at a charge-end voltage of 4.6 V is smaller than that at 4.5 V According to the above results and from the viewpoint of improving capacity, it is preferable that a battery using the positive active material of the exemplary embodiment is used at charge-end voltages ranging from 4.3 to 4.5 V.

In the exemplary embodiment, artificial graphite is used as the negative active material. However, any substance capable of intercalating and de-intercalating lithium ions, such as other carbon materials, i.e. hardly-graphitizable carbon), silicon compounds, and tin compounds, can be used.

In the exemplary embodiment, an example of fabricating a cylindrical battery is described. However, the shape of the battery is not limited to this. The present invention is applicable to coin-, button-, and sheet-shaped, laminated, cylindrical, and flat batteries.

As described above, a non-aqueous electrolyte secondary battery using a method of fabricating the positive active material of the present invention has improved storage characteristics at high temperatures and is expected to be used as a secondary battery for a portable telephone. The secondary battery can also be used as a high power driving source for equipment such as an electric power tool.

What is claimed is:

1. A positive active material for a non-aqueous electrolyte secondary battery, comprising:
a lithium-containing complex oxide capable of intercalating lithium ions;
Li₂CO₃ provided on a surface of the lithium-containing complex oxide;
M1₂CO₃provided on the surface of the lithium-containing complex oxide, M1 being at least one kind of elements selected from a group consisting of H, Na, and Li, and Li₂CO₃being excluded from M1₂CO₃; and
at least one kind of molecules provided on the surface of the lithium-containing complex oxide and selected from a group represented by R—COOM2, R being at least one kind of functional groups selected from a group consisting of alkyl group, alkenyl group, and alkynyl group, and M2 being at least one kind of elements selected from a group consisting of H, Na, and Li.

2. The positive active material for a non-aqueous electrolyte secondary battery of claim 1, wherein the lithium-containing complex oxide has a specific surface area at most 1.0 m²/g.

3. A non-aqueous electrolyte secondary battery comprising:
(1) a positive electrode including a positive active material comprising:
a lithium-containing complex oxide capable of intercalating lithium ions;
Li₂CO₃ provided on a surface of the lithium-containing complex oxide;
M1₂CO₃ provided on the surface of the lithium-containing complex oxide, M1 being at least one kind of elements selected from a group consisting of H, Na, and Li, and Li₂CO₃ being excluded from M1₂CO₃; and
at least one kind of molecules provided on the surface of the lithium-coating complex oxide and selected from a group represented by R—COOM2, R being at least one kind of functional groups selected from a group consisting of alkyl group, alkenyl group, and alkynyl group, and M2 being at least one kind of elements selected from a group consisting of H, Na, and Li:
(2) a non-aqueous electrolytic solution; and
(3) a negative active material for intercalating and de-intercalating lithium ions.

4. The non-aqueous electrolyte secondary battery of claim 3, wherein the lithium-containing complex oxide has a specific surface area at most 1.0 m²/g.

5. A method of fabricating a positive active material for a non-aqueous electrolyte secondary battery, comprising:
A) kneading a lithium-containing complex oxide capable of intercalating lithium ion, and a cellulosic in existence of water;
B) drying the kneaded material; and
C) firing the dried material at a temperature of at least 230° C. and less than a temperature causing oxygen deficiency in the lithium-containing complex oxide.

6. The method of fabricating a positive active material for a non-aqueous electrolyte secondary battery of claim 5, wherein the A step comprises:
D) mixing the lithium-containing complex oxide and cellulosic; and
E) adding water to the mixture and kneading the mixture which includes water.

7. The method of fabricating a positive active material for a non-aqueous electrolyte secondary battery of claim 5, wherein, in the A step, the lithium-containing complex oxide and a solution of the cellulosic are kneaded.

8. The method of fabricating a positive active material for a non-aqueous electrolyte secondary battery of claim 5, wherein, an amount of the cellulosic mixed in the lithium-containing complex oxide is at least 0.01 parts by weight and at most 2.0 parts by weight with respect thereto.

9. The method of fabricating a positive active material for a non-aqueous electrolyte secondary battery of claim 5, wherein, the cellulosic contains at least one of carboxymethyl cellulose and carboxymethylethyl cellulose.

10. A method of charging a non-aqueous electrolyte secondary battery, the battery comprising:
(1) a positive electrode including a positive active material comprising:
a lithium-containing complex oxide capable of intercalating lithium ions;
Li₂CO₃ provided on a surface of the lithium-containing complex oxide;
M1₂CO₃provided on the surface of the lithium-containing complex oxide, M1 being at least one kind of elements selected from a group consisting of H, Na, and Li, and Li₂CO₃being excluded from M1₂CO₃; and
at least one kind of molecules provided on the surface of the lithium-containing complex oxide and selected from a group represented by R—COOM2, R being at least one kind of functional groups selected from a group consisting of an alkyl group, alkenyl group, and alkynyl group, and M2 being at least one kind of elements selected from a group consisting of H, Na, and Li:
(2) a non-aqueous electrolytic solution; and
(3) a negative active material including a carbon material for intercalating lithium ions;
wherein a charge-end voltage of the non-aqueous electrolyte secondary battery is at least 4.3 and at most 4.5 V
